(19) United States
(12) Patent Application Publication
(10) Pub. No.: US 2025/0299062 A1
(43) Pub. Date: Sep. 25, 2025

(54) Data Synthesis Using Generative Models

(71) Applicant: PayPal, Inc., San Jose, CA (US)

(72) Inventors: Vignesh Ravichandran, Ambasamudram (IN); Rajesh Kumar Vashishtha, Khair (IN); Srivignesh Rajan, Coimbatore (IN)

(21) Appl. No.: 18/609,311

(22) Filed: Mar. 19, 2024

(51) Int. Cl. G06N 3/094; G06N 3/045

(52) U.S. Cl. CPC G06N 3/094; G06N 3/045

(57) ABSTRACT

In disclosed techniques a system generates, using a generative model, current synthetic communications, including inputting conditions for the synthetic communications into the trained generative model. The system generates the trained generative model by iteratively performing multiple operations until a discriminator of the generative model determines that synthetic communications output by the generative model satisfy a difference threshold. The operations include: generating, by a generator of the generative model, based on existing communications, a training synthetic communications, determining, by the discriminator of the generative model, differences between the existing communications and the training synthetic communications, and updating the generator based on the differences. Using the current synthetic communications and the existing communications, the system trains another model to evaluate newly initiated communications. The disclosed data synthesis techniques may advantageously enable discovery of concealed patterns, which in turn improves detection of processing systems that execute models trained on the synthetic data.

### BACKGROUND

### Technical Field

This disclosure relates generally to processing data, and, more specifically, to techniques for synthesizing data for training machine learning models e.g., to classify electronic communications.

### Description of the Related Art

Machine learning techniques may be used for processing a wide variety of data. One area of machine learning involves classification of data. For example, a machine learning classifier may be used to classify an image in a binary fashion, such that a classification of “yes” indicates that an image contains a dog, and a classification of “no” indicates that the image does not contain a dog. Machine learning classifiers may be used to classify images, data transfers, transactions, videos, text, etc. As one specific example, electronic communications, such as server-to-server communications may cause substantial loss and security vulnerabilities. Electronic communications that are problematic in some way (e.g., dropped packets, transmission of private user data, malicious activity, etc.) may be identified as such and labeled appropriately so that they can be used by processing systems to detect and address subsequent problematic electronic communications. Using traditional techniques, a processing system may classify electronic communications using a model that is trained based on communications for which labels are known.

### BRIEF DESCRIPTION OF THE DRAWINGS

FIG. 1 is a block diagram illustrating an example system configured to process newly initiated communications based on output of a machine learning model trained on synthetic electronic communication data, according to some embodiments.

FIG. 2 is a block diagram illustrating example training of a generative model, according to some embodiments.

FIG. 3 is a block diagram illustrating example training and execution of a machine learning classifier and an example evaluation module, according to some embodiments.

FIG. 4 is a block diagram illustrating an example database table storing electronic communication data, according to some embodiments.

FIG. 5 is a block diagram illustrating examples of new proposed rules, according to some embodiments.

FIG. 6 is a flow diagram illustrating a method for executing a trained generative model to generate synthetic training data for training a machine learning model to evaluate newly initiated electronic communications, according to some embodiments.

FIG. 7 is a flow diagram illustrating a method for training a generative model to generate synthetic training data for training a machine learning classifier to classify one or more newly initiated electronic communications, according to some embodiments.

FIG. 8 is a block diagram illustrating an example computing device, according to some embodiments.

### DETAILED DESCRIPTION

While processing systems have become much more sophisticated over time, these processing systems may encounter scenarios which they have not encountered before or have not been trained to process. Specifically, these processing systems often become stale over time, as new types of requests are submitted to the system. To combat this staleness, many processing systems are updated after a new scenario or type of communication request is encountered. Such techniques, however, may still allow for these new communications requests to be approved for processing even when they should not. For example, the first time a processing system encounters a new type of communication (i.e., it has not yet been trained on this type of communication), it may approve the communication even though the communication should have been denied. In such situations, the incorrect determination made by the processing system for the new request is considered a “leakage” of the system and often results in loss (e.g., of computational, time, or monetary resources). For example, a processing system has processed a communication with the following variables: an account login request submitted by a user from their device that has a Linux operating system, the log in was submitted via a smart phone, and the phone's geolocation matches geolocation information listed on the user's account. In this example, the processing system will correctly approve the request, because the system knows that this combination of three variables is trustworthy. If, however, the processing system receives a request from the user to transmit private account data to another user via their phone with a Linux operating system, and the phone's geolocation does not match geolocation information listed on the user's account, then the processing system does not know how to classify this request and may end up approving the request even though it should have been denied. For example, the processing system has not been trained on this combination of variables before and, thus, may incorrectly approve the request.

To combat deficiencies in a communication processing system before the deficiencies cause the system to make erroneous decisions, the disclosed techniques proactively simulate new vulnerabilities and new scenarios for training a processing system before the system actually encounters such scenarios. For example, the disclosed techniques use a generative machine learning model, such as a generative adversarial network (GAN) that has been altered to handle tabular data (instead of images data) and trained to generate synthetic data conditioned on the tabular data to simulate new scenarios. Specifically, the disclosed system executes a machine learning model to generate synthetic scenarios for (e.g., attacks on) a processing system in order to train the processing system to deal with real-world versions of these synthetic scenarios before they actually occur. For example, the disclosed techniques are preventative in nature rather than diagnostic, allowing a processing system to identify risky scenarios even when it has not yet encountered such scenarios.

In order to generate synthetic attacks for training a communication processing system, for example, the disclosed techniques synthesize electronic communication by inputting various combinations of variables (conditions) that have not yet occurred in existing communications into a conditional tabular generative adversarial network (CTGAN). The CTGAN learns the distribution of each variable and is conditioned on variables of interest (e.g., certain variable combinations indicate higher risk than others).

To begin synthesizing new scenarios, the disclosed system inputs a set of three variables, also referred to herein as conditions, into the CTGAN. Based on the set of three conditions, the CTGAN generates one or more synthetic training examples. The set of three conditions includes the following types of conditions including the processing system being: able to determine a user's browser language, unable to determine whether the user is copy and pasting within their browser, and unable to determine whether the user is performing mouse movements simultaneously with initiating an electronic communication. This set of conditions indicates a risky scenario that might occur but has not yet been seen by the processing system. For example, the disclosed system may have already encountered three different electronic communications in which one of the following three conditions (i.e., variables) were seen in each of the three different electronic communications: a risk level associated with an email domain of the user's account is not risky in the first communication, the phone number on the user's account is valid in the second communication, and a classifier (e.g., risk) score for a third communication indicates low risk. In this example, the CTGAN (specifically the discriminator of the adversarial network) has not seen a combination of three conditions in a single electronic communication in which a risk level associated with an email domain of the user's account is risky, the phone number on the user's account is invalid, and the classifier score for the single communication indicates high risk. In disclosed techniques, the CTGAN may synthesize an electronic communication that includes these three conditions (via the generator of the CTGAN) because a communication with this combination of conditions (variables) has not yet been synthesized or used to train the disclosed risk detection system.

Based on an input set of conditions, a generator and discriminator of the CTGAN work to generate synthetic training examples corresponding to different sets of variables (different conditions) and to identify differences between the generated synthetic training examples and existing, real-world training examples, respectively. For example, the generator of the CTGAN receives the different conditions as input and outputs synthetic training examples. In contrast, the discriminator of the CTGAN receives both existing training examples and synthetic training examples and attempts to discern differences between the two sets of training examples. The discriminator sends feedback to the generator indicating whether it can tell the difference between the two sets of training examples and what those differences are. In response, the generator makes adjustments, and the process is repeated to generate new synthetic training examples until the discriminator is no longer able to discern differences between the synthetic examples and the existing examples. The synthetic training examples generated by the CTGAN are then used to train a machine learning classifier to identify risky communications.

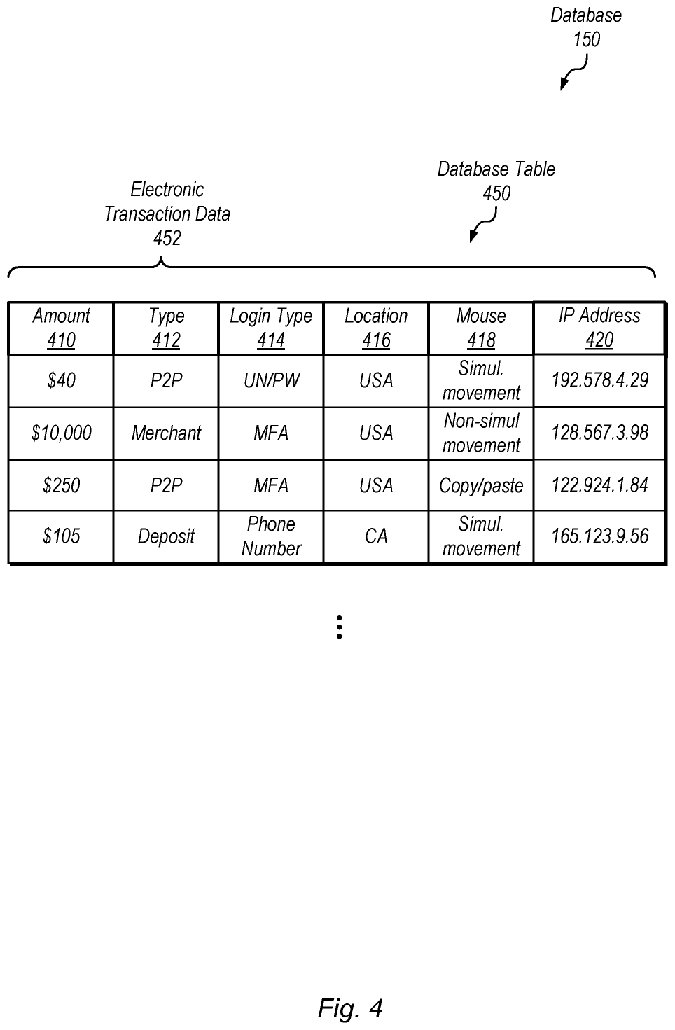

As used herein, the term “classification” refers to a value output by a machine learning model for a set of data indicating a prediction indicative of a particular class to which the set of data should belong. A classification value output by a machine learning model may include, for example, values between 0 and 1. In the context of electronic communications, a value of 0.2 output by a machine learning classifier might indicate that a communication is unsecure, while a value of 0.8 might indicate that the communication is secure. Machine learning classifiers may output classification values indicating a plurality of classes (i.e., instead of the binary classes 0 and 1, there may be several classes 0, 1, 2, and 3; or A, B, and C, etc.). A classification value output by a machine learning model is generated, according to various embodiments, based on a feature vector associated with a given set of data to be classified. As discussed in further detail below with reference to FIG. 4, a feature vector for a communication is generated based on a plurality of variables of the communication. A feature vector associated with a given set of data includes values for a plurality of features. For example, an electronic transaction (one example of an electronic communication) may have a feature vector that includes values for 500, 1000, 10,000, etc. different features (e.g., pieces of data) associated with the transaction, such as: that time at which the transaction was initiated, device identifier (ID), internet protocol (IP) address, user ID, user account name, transaction amount, transaction type, items included in the transaction, age of the user account, currency type, geographic location of a device initiating the transaction, shipping address, billing address, and may other pieces of data.

The disclosed data synthesis techniques may improve the accuracy of machine learning models in processing data stemming from new situations, such as an application associated with new features. As one example, a mobile application has introduced a new customer review variable for electronic transactions. In addition, the disclosed synthetic data realistically replicates intricate patterns that are inherent in real-world data. For example, a malicious end user may formulate a new type of attack to input to the disclosed processing system and instead of handling such an attack in a reactive way (e.g., after the attack has already occurred, the system identifies and uses the attack for future training), the disclosed processing system proactively synthesizes such an attack (or similar attacks) prior to the attack from the end user actually occurring (before the end user attacks the processing system). Subsequently, the synthetic data generated using the disclosed generative techniques enables the discovery of concealed patterns, which in turn fortifies detection and evaluation performed by communication processing systems that include models trained on the synthetic data.

The disclosed techniques may advantageously provide a system for performing predictive and proactive security relative to traditional reactive systems. In addition, the disclosed techniques may advantageously improve the computational efficiency of both generating synthetic training data and training a machine learning model using the synthetic data relative to traditional machine learning techniques. For example, traditionally, if a system were to attempt to generate new training examples from a given set of conditions, the traditional system would generate approximately 500 new training examples from the set of conditions, but only approximately 10 of these new training examples would be relevant (accurately represent the real-world electronic communication equivalent of this training example). For example, if a set of conditions specifies that variable A have the value “x” and variable B have the value “y,” not all of the examples generated using traditional techniques will have these values for these variables and, thus, only the relevant samples (with values x or y for the respective variables) are selected. This process is often referred to as reject sampling. Thus, in this example, the traditional system is approximately only two percent efficient. In contrast, using the disclosed data synthesis techniques, the generative model attempts to generate only training examples from the set of conditions that are relevant (i.e., have values for certain variables that satisfy the condition) and, thus, the disclosed techniques are more efficient than the traditional reject sampling techniques. For example, the disclosed generative model is approximately 60% to 80% efficient as the majority of the samples generated by the generative model have values for the variables specified in the set of conditions.

### Communication Processing System

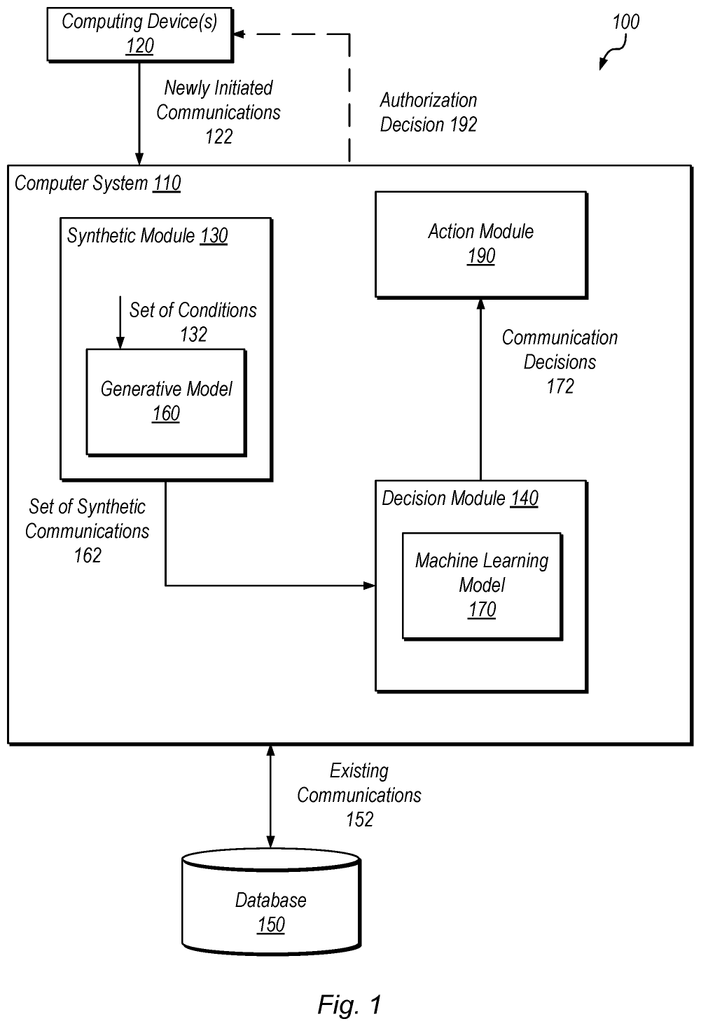

FIG. 1 is a block diagram illustrating an example system configured to process newly initiated communications based on output of a machine learning model trained on synthetic electronic communication data. In the illustrated embodiment, system 100 includes a database 150, one or more computing devices 120, and a computer system 110, which in turn includes a synthetic module 130, a decision module 140, and an action module 190.

In the illustrated embodiment, computer system 110 receives requests for one or more newly initiated communications 122 from one or more computing devices 120. For example, computing device(s) 120 may be user computing devices requesting to initiate electronic communications (e.g., a request to initiate an electronic transaction, an electronic message such as a text message or an email communication, a data transmission such as accessing or sharing private user data, etc.), a server that is part of a network of servers that is requesting to initiate an electronic communication with another server in the network of servers (e.g., a request to transmit a packet of data to another server in the network), a computer that is managing a database system that is requesting to initiate an electronic communication (e.g., a request to transmit data from one database instance to another database instance), etc. In the illustrated embodiment, the one or more computing devices 120 that initiated the one or more electronic communications 122 receive an authorization decision 192 from computer system 110 indicating whether the requested communications are approved or rejected.

Computer system 110, in the illustrated embodiment, executes synthetic module 130 to generate a set 162 of synthetic communications based on a set 132 of conditions. For example, synthetic module 130 inputs a set 132 of conditions into a trained generative model 160 and the generative model 160 outputs a set 162 of synthetic communications. In some embodiments, the set 132 of conditions for the synthetic communications includes categorical features based on which the synthetic communications are generated. For example, synthetic module 130 may generate categorical features based on categorical variables and numerical variables of a set of existing communications. Synthetic module 130 generates one or more conditions in the set of conditions for the synthetic communications by generating a first set of categorical features from categorical variables of existing electronic communications. Further, synthetic module 130 generates one or more conditions by transforming, using one or more feature transformation techniques, numerical features of the existing electronic communications to generate a second set of categorical features. As one example, synthetic module 130 may transform numerical features of existing electronic communications using z-scaling. Synthetic module 130, in the illustrated embodiment, sends the set 162 of synthetic communications to decision module 140.

Decision module 140, in the illustrated embodiment, trains a machine learning model 170 using at least the set 162 of synthetic communications. In some embodiments, machine learning model 170 is a machine learning classifier. For example, model 170 might be a neural network, decision tree, logistic regression model, etc. Decision module 140 trains a classifier to classify newly initiated communications 122. The classifications output by the classifier during (and after) training indicate whether communications are closer to one of two classes, as discussed above. Decision module 140 determines whether the machine learning model 170 is able to correctly identify whether synthetic communications in set 162 are unsecure or atypical. For example, decision module 140 compares the classifications with known labels for the synthetic communications. If they match (or are within a threshold similarity), then decision module 140 does not retrain machine learning model 170. If, however, the classifications output by model 170 for the synthetic communications in set 162 do not match the known labels (or differ within a threshold amount), then decision module 140 retrains train machine learning model 170. In some embodiments, decision module 140 retrains machine learning model 170 using new rules (corresponding to incorrectly classified synthetic communications) until model 170 is able to correctly classify synthetic communications in the set 162.

Once decision module 140 is satisfied with the training of machine learning model 170 based on synthetic data, decision module 140 inputs newly initiated communications 122 into the trained version of model 170 to generate classifications for communications 122. Based on classifications output by a retrained version of machine learning model 170 for newly initiated communications 122, decision module 140 generates decisions 172 for the different communications and transmits the decisions to action module 190. For example, decision module 140 may compare the classifications output by the trained version of model 170 with one or more decision thresholds. If a classification is above a decision threshold, then decision module 140 might transmit a communication decision 172 to module 190 indicating that the newly initiated communication 122 corresponding to the classification is unsecure. If a classification is between two thresholds, then decision module 140 might transmit a communication decision 172 to module 190 indicating that the newly initiated communication 122 corresponding to the classification is potentially unsecure.

Action module 190, in the illustrated embodiment, receives communication decisions 172 from decision module 140 for the newly initiated communications 122 and generates authorization decisions 192 for the communications 122. For example, preventative module 190 determines, based on a communication decision 172, that a newly initiated communication 122 is atypical (e.g., risky, suspicious, malicious, etc.). Based on this determination, action module 190 selects one or more actions to perform relative to communication 122. For example, action module 190 may select one or more preventative actions to perform relative to the newly initiated communication 122 that is atypical, such as rejecting the one or more newly initiated communications, escalating authentication for the one or more newly initiated communications, transmitting the one or more newly initiated communications for additional review, etc. Action module 190, in the illustrated embodiment, causes an authorization decision for the newly initiated communication 122 to be transmitted to a computing device 120 that requested the communication 122.

The disclosed synthetic training techniques may be applied to any of various types of machine learning models used for any of various applications and are not limited to the examples described herein. The disclosed techniques may be used in processing images, decisions for self-driving cars, requests to access private data, database operations, etc. and are not limited to electronic communications. Said another way, the presently disclosed techniques are widely applicable to the field of machine learning and are not limited to only classification of electronic communications—though for ease of understanding many examples discussed herein relate to the field of electronic communication classification.

### Example Generative Model

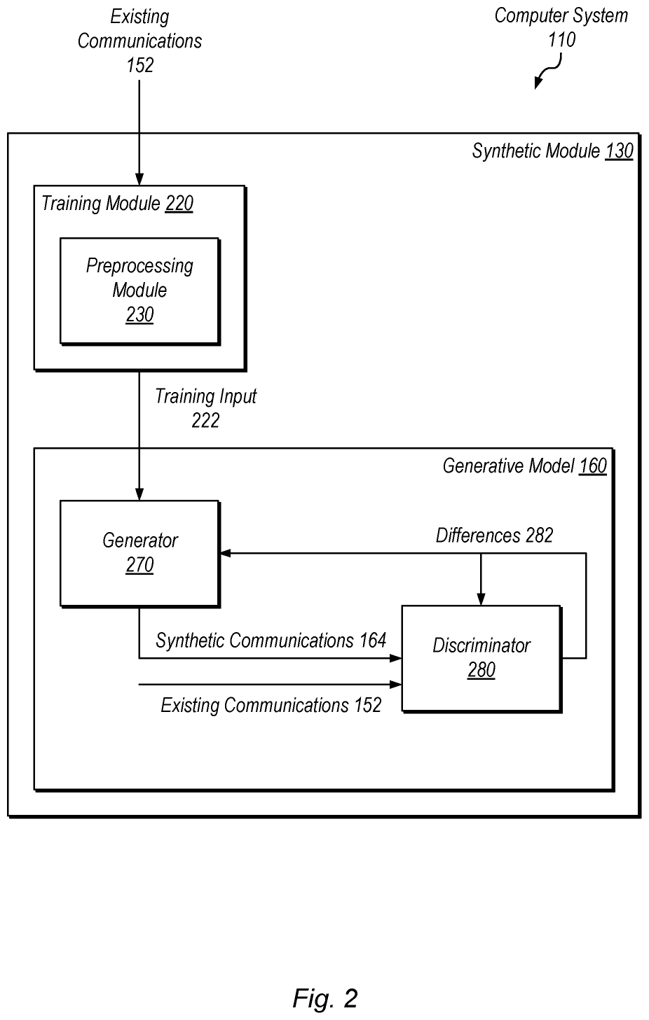

Turning now to FIG. 2, a block diagram illustrating example training of a generative model is shown. In the illustrated embodiment, synthetic module 130 includes training module 220, which in turn includes preprocessing module 230 and generative model 160. While generative adversarial networks are generally used to process image data, computer system 110 trains and executes a GAN on electronic communication data. For example, instead of feeding images into a GAN and receiving output consisting of new images that are different than the images fed into the model, computer system 110 feeds electronic communications data, particularly one or more conditions (variables) from existing electronic communication and receives newly generated (synthetic) electronic communications as output. In particular, the communication data is tabular data, and the GAN learns the distribution for each condition it receives as input. During training, for example, based on the multivariate distribution (e.g., the distribution of different variables), in each iteration of the GAN a condition is selected for the generator and the discriminator of the GAN. In this example, for a particular condition, the GAN learns patterns associated with all the other variables together (the variables besides the selected particular condition/variable). In this way, the trained GAN is able to conditionally generate patterns for different specified conditions. As used herein, the term “tabular data” is intended to be construed according to its well-understood meaning, which includes data that is arranged in a specific file format, often rows and columns. For example, data stored in a comma-separated values (CSV) file is considered tabular data. As another example, the disclosed tabular data may be stored in database tables, in an extensible markup language (XML) file, using Apache Parquet™, in a JavaScript Object Notation (JSON) file, in a Pandas DataFrame, in a pickle byte stream, etc.

Synthetic module 130, in the illustrated embodiment, inputs existing communications 152 (retrieved from database 150 as shown in FIG. 1) into training module 220. Training module 220, in the illustrated embodiment, executes preprocessing module 230 to generate training input 222. For example, training module 220 executes preprocessing module 230 to generate two or more preprocessed communications for use in training generative model 160. Preprocessing module 230 performs one or more preprocessing techniques to alter variables of the existing communications, resulting in various features for the existing communications. Training module 220 feeds these features into generator 270 of generative model 160 as training input 222. As discussed above with reference to FIG. 1, synthetic module 130 transforms numerical attributes of existing electronic communications using z-scaling.

As discussed above, in various embodiments, prior to inputting training examples 152 (i.e., existing communications 152) into a machine learning model during training, computer system 110 preprocesses the training examples using one or more data transformation techniques such as data normalization. When determining a particular data transformation technique to implement, computer system 110 may consider types of features included in the training examples 152. For example, if the training examples 152 include primarily continuous features (values of these features are a range of values e.g., $0 to $500), computer system 110 selects a z-scaling technique. Z-scaling includes centering data values around a mean value and dividing these data values by the standard deviation of the data values. Transforming training examples using z-scaling techniques includes capping of normalization beyond several standard deviations, for example. Computer system 110 may alternatively or additionally perform imputation of categorical variables using mode. As another example, computer system 110 performs imputation of numerical variables using median. Further, computer system 110 may perform conversion of a set of important numeric variables to categorical variables using binding. This type of variable transformation may advantageously allow generative model 160 to learn relevant patterns based on the transformed variables. Additionally, or alternatively, for high cardinality categorical variables, computer system 110 may select the top N values (e.g., top thirty values) based on their frequency of occurrence and categorize the remaining variables as “others.” In various embodiments, a variable that is taken from an existing communication 152 and transformed in some way by training module 220 is referred to herein as a “feature” or “condition.” For example, training input 222 fed into generator 270 of generative model 160 is referred to herein as “conditions” and each condition is a “feature” that is generated by preprocessing a variable of an electronic communication.

Training module 220, in the illustrated embodiment, sends training input 222 to generative model 160 for input to the generator 270 of model 160. Training input 222 includes preprocessed variables for existing communications 152, for example. In some embodiments, training input 222 also includes some amount of noise added by training module 220. For example, during training of model 160, training module 220 inputs noise into generator 270 along with the existing communications 152 to add variance to examples generated by generator 270. In some embodiments, the noise added by training module 220 is generated from a multivariate standard normal distribution referred to herein as “z-noise.” Generator 270, in the illustrated embodiment, outputs synthetic communications 164 generated based on the training input 222. For example, a synthetic communication 164 output by generator 270 may include seven different variables, one variable from each of seven different existing communications 152. Generative model 160 further includes discriminator 280 which receives the synthetic communications 164 output by generator 270 as well as the existing communications 152 (retrieved from database 150 as discussed above with reference to FIG. 1) as input.

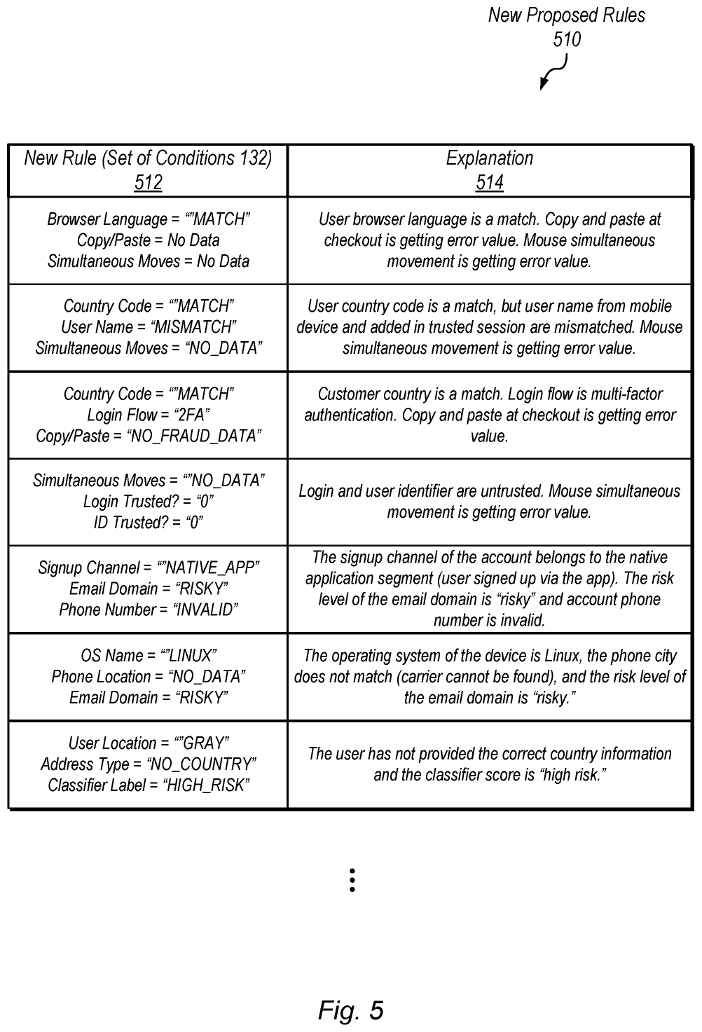

In some embodiments, the one or more conditions included in training input 222 include one or more conditions of the following types of conditions: categorical features that include both categorical variables and numerical variables of the set of existing communications, numerical features of the set of existing communications that have been transformed using one or more feature transformation techniques, a conditional vector of features that includes a subset of a set of features for the set of existing communications, and features of the set of existing communications that include anomalous labels. To generate the categorical features, for example, preprocessing module 230 performs one or more discretizing or binning techniques on the numerical variables of existing communications 152 in order to transform them into categorical data. Such techniques allow generative model 160 to be conditioned on numerical features as well as categorical features. As discussed in further detail below with reference to FIG. 5, a given training input 222 may include a set of conditions 132 (which later may be introduced as a new rule for training a machine learning classifier) that includes three different conditions separated from one or more existing communications 152 by training module 220.

In some embodiments, training module 220 generates training input 222 by selecting a conditional vector (set of conditions 132) that encapsulates a set of conditioning variables and their values. This vector is utilized to guide the generation of synthetic data, providing a more precise and efficient solution than if the training module 220 were to input all conditions (all variables from existing communications) into the generative model 160 and, subsequently, filter out for specific conditions. For example, the training module 220 performs more efficient training than generative model 160 by using only the synthetic communications that include desired conditions during training.

In the illustrated embodiment, discriminator 280 provides a feedback loop for generative model 160 by sending one or more differences 282 identified between ones of synthetic communications 164 and existing communications 152. Based on this feedback, generator 270 adjusts one or more weights such that is generates future synthetic communications differently. In addition, discriminator 280 has a feedback loop to itself to track how differences 282 between synthetic and existing communications change with each iteration of generative model 160 during training. This process between the generator 270 and discriminator 280 repeats until training module 220 is satisfied with the differences 282 between synthetic and existing communications being less than some threshold. As one example, once discriminator 280 can no longer determine the difference (or can no longer identify more than a threshold number of differences) between synthetic and existing (e.g., fake vs. real) communications, generative model 160 is considered to be “trained” by training module 220 and is ready for execution in production.

### Example Machine Learning Classifier

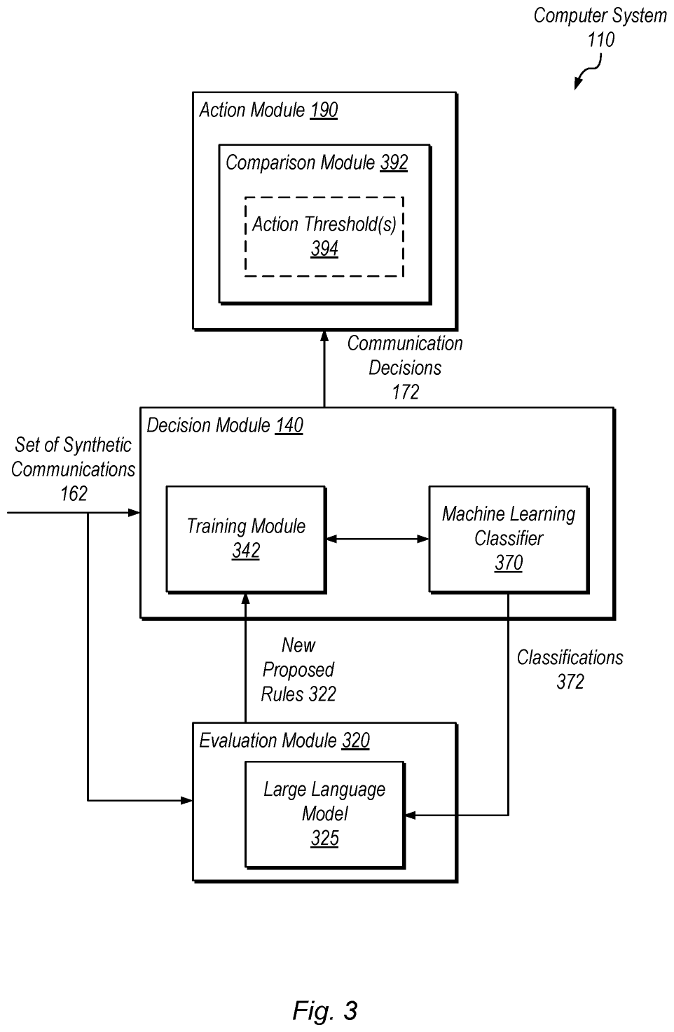

FIG. 3 is a block diagram illustrating example training and execution of a machine learning classifier and an example evaluation module. In the illustrated embodiment, computer system 110 includes action module 190, decision module 140, and evaluation module 320. Decision module 140, in the illustrated embodiment, includes training module 342 and machine learning classifier 370, while evaluation module 320 includes large language model 325.

Decision module 140, in the illustrated embodiment, receives set 162 of synthetic communications (from synthetic module 130 as shown in FIG. 1 and discussed in detail above) and trains machine learning classifier 370 via training module 342. For example, decision module 140 executes training module 342 which inputs the set 162 of synthetic communications into machine learning classifier 370. Classifications 372 output by machine learning classifier 370 for the synthetic communications in set 162 are fed back to training module 342 for evaluation as well as input to the large language model 325 of evaluation module 320, as shown in the illustrated embodiment. The decision module 140 and evaluation module 320 of computer system 110 work together to use synthetic data generated by the generative model 160 (shown in FIGS. 1 and 2) to feed potential new scenarios into an existing, trained learning classifier 370. These new potential scenarios are used to check whether this trained model is able to defend computer system 110 against potential new attacks, for example. If the classifier 370 is unable to defend against (i.e., correctly classify synthetic communications), then decision module 140 retrains the classifier using new rules. These new rules correspond to synthetic communications that were incorrectly classified by the classifier 370. Such retraining techniques may advantageously allow machine learning classifier 370, when executed by computer system 110, to accurately identify and subsequently prevent such attacks from occurring in the future.

Once training module 342 is satisfied with the training of machine learning classifier 370, decision module 140 executes the trained (or retrained) version of machine learning classifier 370 to generate communication decisions 172 for newly initiated electronic communications. Decision module 140, in the illustrated embodiment, transmits the communication decisions 172 to action module 190. As discussed above with reference to FIG. 1, action module 190 makes authorization decisions 192 for newly initiated electronic communications based on communication decisions 172 generated by decision module 140. Action module 190, in the illustrated embodiment, includes comparison module 392 which compares the communication decisions 172 with one or more action thresholds 394. Based on this comparison, action module 190 selects one or more actions to perform relative to a corresponding newly initiated electronic communication. For example, action module 190 may select an action such as transmitting to a computing device 120 associated with a requested communication, an authorization decision indicating that the requested communication is not authorized. As another example, action module 190 may select an action such as rejecting the requested communication (without notifying the corresponding requesting entity). As yet another example, action module 190 may select to escalate authentication for a newly initiated electronic communication, such as requiring additional authentication factors from an entity associated with a computing device 120 that submitted the request. Further, action module 190 may select an action such as transmitting a newly initiated communication for additional review e.g., by a system administrator or a manager associated with the request.

Evaluation module 320, in the illustrated embodiment, executes large language model 325 to receive classifications 372 of classifier 370 as input and output new proposed rules 322 for use in retraining classifier 370. For example, large language model 325 generates a summary of synthetic communications 162 based on classifications 372 output by classifier 370 for the communications 162. For example, the summary indicates whether the classifier incorrectly classified these communications. Based on this summary, evaluation module 320 may select a subset of the communications in the summary and indicate that these communications should be used to retrain classifier 370. As one example, the summary output by model 325 may include a table of 1000 rows of different sets of conditions as discussed below with reference to FIG. 5 and whether these conditions resulted in a synthetic communication 162 that was incorrectly classified by classifier 370. In this example, evaluation module 320 may select the first three, five, ten, etc. most commonly occurring sets of conditions to be used to retrain classifier 370. In some embodiments, the new proposed rules 322 include one or more synthetic communications 162 to be used to retrain machine learning classifier 370. In other embodiments, the new proposed rules 322 indicate one or more weights that should be adjusted within classifier 370 during retraining.

In some embodiments, evaluation module 320 executes large language model 325 to evaluate synthetic communications 162 prior to using the synthetic communications to train classifier 370. For example, instead of inputting the generated synthetic communications 162 across all conditions into classifier 370, evaluation module 320 uses large language model 325 to identify the dominant conditions in the synthetic communications 162. In this example, evaluation module 320 uses only communications included in synthetic communications 162 that correspond to the identified dominant conditions to train classifier 370.

As discussed above, evaluation module 320 works with decision module 140 to determine whether machine learning classifier 370 requires additional training based on the output of classifier 370 for synthetic communications in set 162. For example, the disclosed computer system 110 executes a large language model (LLM) to receive output of machine learning classifier 170 that is newly trained on synthetic communications generated by the CTGAN from a given set of conditions. For example, LLM model 325 receives different communications that have classifications generated by classifier 370 indicating whether they are risky or not. Based on these classifications meeting a threshold classification, LLM model 325 outputs information indicating that a rule corresponding to the communications should be used to train classifier 370 for future real-world communications that might be initiated in the future.

In some embodiments, LLM model 325 outputs a summary of communications with a given combination of variables that led to a misclassification by the classifier 370. For example, if the classifier 370 mis-classifies a large number of communications that do not have copy past data or mouse movement data available for the user, then the LLM model will flag this group of communications and decision module 140 will select these variables as a set of conditions (i.e., no copy past data or mouse movement data is available) for a new rule for use in retraining the classifier 370. In this example, if there are more than a threshold number of communications having these variables that were not correctly classified by the classifier, this indicates to decision module 140 that this is an area in which the classifier requires further training.

In various embodiments, evaluation module 230 performs these actions in an automated manner to analyze the “leakage” of classifier 370 and determine whether to alter rules used to train machine learning classifier 370. The outputs of decision module 140 and evaluation module 320 include tabular data in the form of e.g., thousands of rows of conditions (e.g., of different electronic communication scenarios) and whether or not they were leaked (mis-classified) by the classifier 370 (e.g., the security system). The “leakage” of classifier 370 is fed into LLM model 325 to generate a summary indicating the most common pattern(s) of communication data that resulted in a leakage of the classifier 370.

FIG. 4 is a block diagram illustrating an example database table storing electronic communication data. In the illustrated embodiment, database 150 is shown storing a database table 450 that includes several columns which store values for the following features, where each row corresponds to a different electronic transactions (one example of electronic communications): amount 410, type 412, login type 414, location 416, mouse 418, and Internet protocol (IP) address 420. In some embodiments, the values stored in table 450 include raw electronic transaction data. In other embodiments, the values stored in table 450 are preprocessed features that are generated from the raw electronic transaction data 452 via one or more of the preprocessing techniques discussed above with reference to FIG. 2.

While the example table shown in FIG. 4 includes only six different features, in various embodiments, transactions may have thousands of features. Examples of transaction features include: IP address, transaction location, account credentials, screen resolution, browser type, hardware characteristics (e.g., of a user's mobile phone, desktop computer, etc.), etc. Table 450, in the illustrated embodiment, includes four different electronic communications with values for various features. For example, in the first row of table 450, a person-to-person electronic transaction for 40 U.S. dollars (USD) was submitted from an account that was logged into using a username and password in the United States. Simultaneous mouse movement was detected for this transaction with an IP address of 192.578.4.29. The transaction in the second row of table 450 is between a merchant and a customer for 10,000 USD. This transaction was initiated from an account that was logged into via multi-factor authentication (MFA) and no mouse movement was detectable for this transaction. The third row of table 450 is another person-to-person transaction for 250 USD with detectable copy and paste data for the transaction. Finally, the fourth row of table 450 shows a transaction that is depositing $105 into a bank account of the user who supplies their phone number during authentication, is initiated in Canada, and includes corresponding mouse movement from the user and has an IP address of 165.123.9.56.

In some embodiments, the examples stored in database table 450 are instances of the training examples 162 (existing communications) that are used by generative model 160 to generate synthetic communications. In other embodiments, these transactions are instances of the synthetic communications 162 generated by generative model 160 (as discussed above with reference to FIG. 1) to test the robustness of or to retrain machine learning model 170 to classify e.g., future transactions. The examples included in table 450 may be transactions completed using the PayPal™ platform, for example.

Turning now to FIG. 5, a block diagram illustrating examples of new proposed rules is depicted. In the illustrated embodiment, several new rules 512 with corresponding rule explanations 514 are shown. In the illustrated embodiment, each new rule 512 includes a set of conditions 132, discussed above with reference to FIGS. 1-3. For example, each new rule 512 includes three different conditions. Each new rule 512 includes different conditions that must be met to trigger the new rule 512.

As discussed above with reference to FIG. 3, one or more new rules 512 may be used by decision module 140 to retrain machine learning classifier 370. For example, the first row of the new proposed rules table 510 includes a new rule 512 specifying three different criteria: browser language=“MATCH”, copy/paste=no suspicious data, and simultaneous moves=no data. Decision module 140 may use this new rule to tarin machine learning classifier 370 to identify newly requested communications (e.g., transactions) that meet the three conditions included in new rule 512 as unsecure or risky, for example. In some embodiments, new rules 512 (i.e., sets of conditions 132) are used by generative model 160 when generating synthetic communications 162 to determine leakages of model 170. For example, if a set of conditions 132 is used to generate synthetic communications that machine learning model 170 incorrectly classifies, then computer system 110 may select this particular set of conditions 132 as a new “rule” to be used to retrain the model 170 such that it is able to correctly classify future newly initiated communications with variables that are similar to or the same as the conditions 132 in the new rule. While seven example new rules 512 are shown in FIG. 5, the disclosed system may generate any of various numbers of new rules 512 to be implemented by computer system 110 when processing electronic communications.

The explanation 514 for the new rule 512 shown in the first row of table 510 specifies that if a user's browser language is the same as an expected language (e.g., a language previously used on this user's device when interacting with the disclosed processing system), then the value for the browser language criteria is “MATCH.” Further, rule explanation 514 for the new rule 512 in the first row of table 510 specifies that if the user does not perform a copy and paste action when they are attempting to complete a checkout process, then the value for the copy/paste criteria is “no data” indicating that the user may be blocking computer system 110 from seeing their copy and paste activity within their browser when attempting to complete an electronic transaction. The rule explanation 514 for the third criteria for the first new rule 512 in table 510 specifies that if there is no simultaneous mouse movement detected on the user's device (e.g., during a checkout process), then the value for the “simultaneous moves” criteria is “no data.” For example, when a user is attempting to initiate an electronic transaction via their device, the disclosed server system will detect mouse movement at the user's device. In this example, the system detects the mouse movement via an application downloaded (e.g., a PayPal application) or a web browser currently open on the user's device which transmit the mouse movement data to the backend server. Further in this example, the server analyzes the mouse movement data to determine whether the user made simultaneous mouse movements when submitting the request to initiate a transaction. The disclosed processing system (e.g., computer system 110 discussed above with reference to FIG. 1) performs similar processes to detect copy and paste data, location data, browser language data, etc. for the user submitting the request to initiate an electronic transaction.

For the first new rule 512 in table 510, if the three condition values for a newly initiated communication are the same as those shown in the first column of table 510, then this new rule 512 is triggered and the disclosed processing system performs one or more preventative actions for the electronic communication. In the context of FIG. 3, machine learning classifier 370 classifies the electronic transaction as unsecure and action module selects one or more actions to perform relative to the unsecure communication.

The explanation 514 for the second new rule 512 in the second row of table 510 specifies that a user's phone number country code matches an automated clearing house (ACH) country used for the transaction, but that the user's name given during the transaction request does not match a name stored for this user in association with their phone number. Further, the second row of table 510 indicates that there is no detectable data for a user's mouse movement. Similarly, the examples in rows three through seven of table 510 include conditions such as whether the login information or user identifier for a transaction are untrusted, which application the user employed to sign into their account (e.g., whether the signup channel was a native mobile application, web browser, etc.), whether an email domain determined for a user requesting a transaction is risky, whether a user's phone number is invalid, what the operating system of the user's device is, whether a user's current geographic location matches a location on file for the user (e.g., is the user located in the same city or country stored on file), an address type for the user (e.g., is the address complete or missing information?), a classifier score/label for this user's account, etc.

### Example Methods

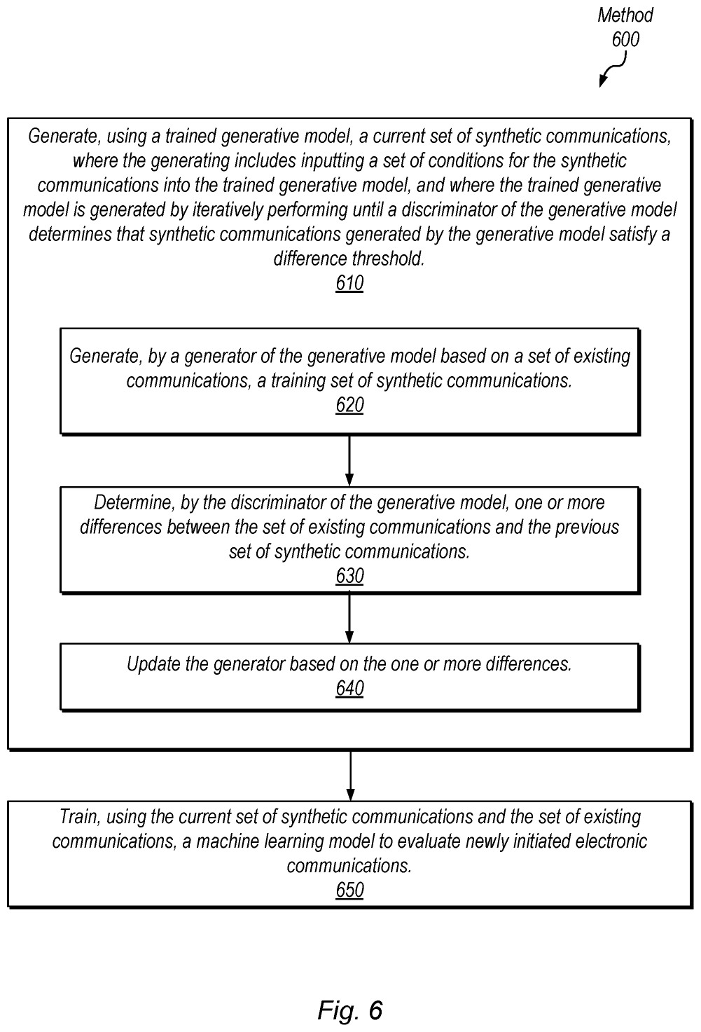

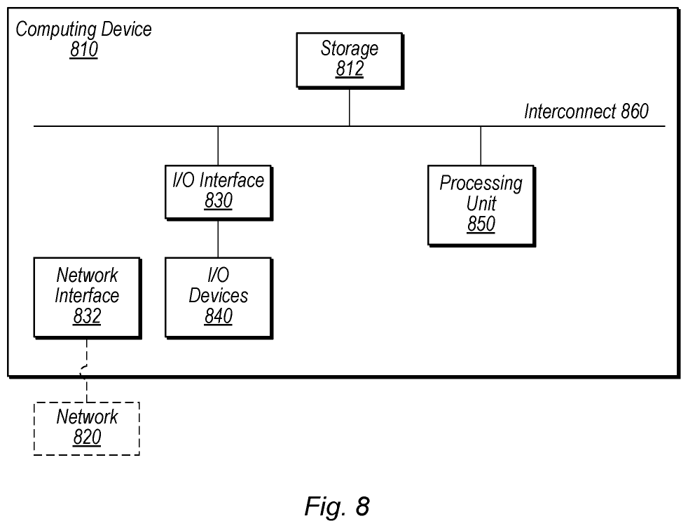

FIG. 6 is a flow diagram illustrating a method 600 for executing a trained generative model to generate synthetic training data for training a machine learning model to evaluate newly initiated electronic communications, according to some embodiments. The method shown in FIG. 6 may be used in conjunction with any of the computer circuitry, systems, devices, elements, or components disclosed herein, among other devices, such as those discussed below with reference to FIG. 8. Computing device 110, shown in FIG. 1 and discussed in detail above, is one example computer system that may be used to perform method 600. In various embodiments, some of the method elements shown may be performed concurrently, in a different order than shown, or may be omitted. Additional method elements may also be performed as desired.

At 610, in the illustrated embodiment, a computer system generates, using a trained generative model, a current set of synthetic communications, where the generating includes inputting a set of conditions for the synthetic communications into the trained generative model. In some embodiments, the computer system generates the generative model by iteratively performing elements 620-640 until a discriminator of the generative model determines that synthetic communications generated by the generative model satisfy a difference threshold. In some embodiments, synthetic communications generated by the trained generative model simulate new types of atypical communications that are different than atypical communications included in the set of existing communications.

In some embodiments, the set of conditions for the synthetic communications includes conditions based on which the synthetic communications are generated: categorical features that include both categorical variables and numerical variables of the set of existing communications. In some embodiments, the computer system generates one or more conditions in the set of conditions for the synthetic electronic communications, based on which the synthetic electronic communications are generated. In some embodiments, generating the one or more conditions includes generating a first set of categorical features from categorical variables of the existing electronic communications. In some embodiments, generating the one or more conditions includes transforming, using one or more feature transformation techniques, numerical features of the existing electronic communications to generate a second set of categorical features. In some embodiments, the set of conditions includes at least three different variables, the combination of which does not appear in existing electronic communications.

At 620, the computer system generates the trained generative model by: generating, by a generator of the generative model based on a set of existing communications, a training set of synthetic communications. In some embodiments, the generative model is a conditional tabular generative adversarial network (CTGAN).

At 630, the computer system generates the trained generative model by: determining, by the discriminator of the generative model, one or more differences between the set of existing communications and the training set of synthetic communications. In some embodiments, the discriminator of the generative model does not identify one or more differences. In such embodiments, the output of the discriminator indicates that the generative model is satisfactorily trained (e.g., the discriminator is not able to tell the difference between the synthetic communications and existing communications. For example, the existing communications are ones that were previously processed (e.g., approved or denied) by the computer system.

At 640, the computer system generates the trained generative model by: updating the generator based on the one or more differences. In some embodiments, the trained generative model is further generated by identifying, by the discriminator of the generative model based on the one or more differences, whether ones of the set of existing communications and the set of synthetic communications are synthetic.

At 650, the computer system trains, using the current set of synthetic communications and the set of existing communications, a machine learning model to evaluate newly initiated electronic communications. In some embodiments, the computer system identifies, using the trained machine learning model, one or more newly initiated communications as atypical. In some embodiments, the computer system identifies newly initiated communications as anomalous. For example, a communication may be unsecure (e.g., risky, malicious, access private data, etc.). In some embodiments, the computer system performs, based on identifying one or more newly initiated communications as atypical, one or more actions corresponding to the atypical newly initiated communications. In some embodiments, the one or more actions include one or more of the following types of actions: rejecting the one or more newly initiated communications, escalating authentication for the one or more newly initiated communications, and transmitting the one or more newly initiated communications for additional review.

In some embodiments, the computer system inputs output of the machine learning model during training into a large language model (LLM), where the output of the machine learning model includes classifications for one or more of the set of synthetic communications and the set of existing communications input to the machine learning model during training. In some embodiments, the computer system automatically alters, based on comparing output of the LLM with known labels for the set of synthetic communications and the set of existing communications, the machine learning model.

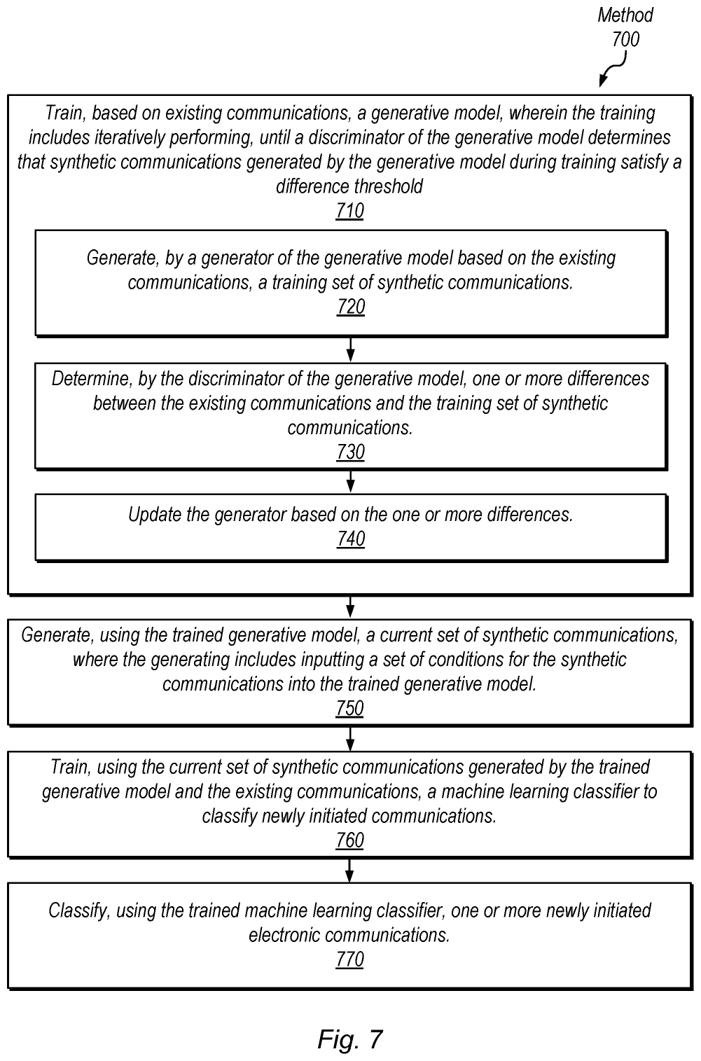

Turning now to FIG. 7, a flow diagram is shown illustrating a method 700 for training a generative model to generate synthetic training data for training a machine learning classifier to classify one or more newly initiated electronic communications, according to some embodiments. The method shown in FIG. 7 may be used in conjunction with any of the computer circuitry, systems, devices, elements, or components disclosed herein, among other devices, such as those discussed below with reference to FIG. 8. Computing device 110, shown in FIG. 1 and discussed in detail above, is one example computer system that may be used to perform method 700. In various embodiments, some of the method elements shown may be performed concurrently, in a different order than shown, or may be omitted. Additional method elements may also be performed as desired.

At 710, in the illustrated embodiment, a computer system trains, based on existing communications, a generative model, where the training includes iteratively performing elements 720-740 until a discriminator of the generative model determines that synthetic communications generated by the generative model during training satisfy a difference threshold. In some embodiments, synthetic communications generated by the trained generative model simulate new types of atypical communications that are different than atypical communications included in the set of existing communications.

At 720, the computer system generates the trained generative model by: generating, by a generator of the generative model based on the existing communications, a training set of synthetic communications. In some embodiments, the generative model is a generative adversarial network (GAN).

At 730, the computer system generates the trained generative model by: determining, by the discriminator of the generative model, one or more differences between the existing communications and the training set of synthetic communications. In some embodiments, the discriminator of the generative model does not identify one or more differences. In such embodiments, the output of the discriminator indicates that the generative model is satisfactorily trained (e.g., the discriminator is not able to tell the difference between the synthetic communications and existing communications. For example, the existing communications are ones that were previously processed (e.g., approved or denied) by the computer system.

At 740, the computer system generates the trained generative model by: updating the generator based on the one or more differences. In some embodiments, the trained generative model is further generated by identifying, by the discriminator of the generative model based on the one or more differences, whether ones of the set of existing communications and the set of synthetic communications are synthetic.

At 750, the computer system generates, using the trained generative model, a current set of synthetic communications, where the generating includes inputting a set of conditions for the synthetic communications into the trained generative model. In some embodiments, the set of conditions for the synthetic communications includes one or more of the following types of conditions based on which the synthetic communications are generated: categorical features that include both categorical variables and numerical variables of the set of existing communications. In some embodiments, the computer system generates one or more conditions in the set of conditions for the synthetic electronic communications, based on which the synthetic electronic communications are generated. In some embodiments, generating the one or more conditions includes generating a first set of categorical features from categorical variables of the existing electronic communications. In some embodiments, generating the one or more conditions includes transforming, using one or more feature transformation techniques, numerical features of the existing electronic communications to generate a second set of categorical features. In some embodiments, the set of conditions includes at least three different variables, the combination of which does not appear in existing electronic communications.

At 760, the computer system trains, using the current set of synthetic communications generated by the trained generative model and the existing communications, a machine learning classifier to identify classify newly initiated communications. In some embodiments, the computer system inputs output of the machine learning classifier during training into a large language model (LLM), where the output of the machine learning model includes classifications for one or more of the set of synthetic communications and the set of existing communications input to the machine learning model during training. In some embodiments, the computer system automatically alters, based on comparing output of the LLM with known labels for the set of synthetic communications and the set of existing communications, the machine learning model.

At 770 the computer system classifies, using the trained machine learning classifier, one or more newly initiated electronic communications. In some embodiments, the computer system classifies, using the trained machine learning classifier, one or more newly initiated communications as anomalous. For example, a communication may be unsecure (e.g., risky, malicious, access private data, etc.). In some embodiments, the computer system performs, based on classifying one or more newly initiated communications as anomalous, one or more actions corresponding to the anomalous newly initiated communications. In some embodiments, the one or more actions include one or more of the following types of actions: rejecting the one or more newly initiated communications, escalating authentication for the one or more newly initiated communications, and transmitting the one or more newly initiated communications for additional review.

### Example Computing Device

Turning now to FIG. 8, a block diagram of one embodiment of computing device (which may also be referred to as a computing system) 810 is depicted. Computing device 810 may be used to implement various portions of this disclosure. Computing device 810 may be any suitable type of device, including, but not limited to, a personal computer system, desktop computer, laptop or notebook computer, mainframe computer system, web server, workstation, or network computer. Note that various machine learning techniques discussed herein may be performed by computing device 810, for example. As shown, computing device 810 includes processing unit 850, storage 812, and input/output (I/O) interface 830 coupled via an interconnect 860 (e.g., a system bus). I/O interface 830 may be coupled to one or more I/O devices 840. Computing device 810 further includes network interface 832, which may be coupled to network 820 for communications with, for example, other computing devices.

In various embodiments, processing unit 850 includes one or more processors. In some embodiments, processing unit 850 includes one or more coprocessor units. In some embodiments, multiple instances of processing unit 850 may be coupled to interconnect 860. Processing unit 850 (or each processor within 850) may contain a cache or other form of on-board memory. In some embodiments, processing unit 850 may be implemented as a general-purpose processing unit, and in other embodiments it may be implemented as a special purpose processing unit (e.g., an ASIC). In general, computing device 810 is not limited to any particular type of processing unit or processor subsystem.

Storage subsystem 812 is usable by processing unit 850 (e.g., to store instructions executable by and data used by processing unit 850). Storage subsystem 812 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage subsystem 812 may consist solely of volatile memory, in one embodiment. Storage subsystem 812 may store program instructions executable by computing device 810 using processing unit 850, including program instructions executable to cause computing device 810 to implement the various techniques disclosed herein.

I/O interface 830 may represent one or more interfaces and may be any of various types of interfaces configured to couple to and communicate with other devices, according to various embodiments. In one embodiment, I/O interface 830 is a bridge chip from a front-side to one or more back-side buses. I/O interface 830 may be coupled to one or more I/O devices 840 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

Unless stated otherwise, the specific embodiments are not intended to limit the scope of claims that are drafted based on this disclosure to the disclosed forms, even where only a single example is described with respect to a particular feature. The disclosed embodiments are thus intended to be illustrative rather than restrictive, absent any statements to the contrary. The application is intended to cover such alternatives, modifications, and equivalents that would be apparent to a person skilled in the art having the benefit of this disclosure.

Particular features, structures, or characteristics may be combined in any suitable manner consistent with this disclosure. The disclosure is thus intended to include any feature or combination of features disclosed herein (either explicitly or implicitly), or any generalization thereof. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to the singular forms such “a,” “an,” and “the” are intended to mean “one or more” unless the context clearly dictates otherwise. Reference to “an item” in a claim thus does not preclude additional instances of the item.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” covering x but not y, y but not x, and both x and y. On the hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one of element of the set [w, x, y, z], thereby covering all possible combinations in this list of options. This phrase is not to be interpreted to require that there is at least one instance of w, at least one instance of x, at least one instance of y, and at least one instance of z.

Various “labels” may proceed nouns in this disclosure. Unless context provides otherwise, different labels used for a feature (e.g., “first circuit,” “second circuit,” “particular circuit,” “given circuit,” etc.) refer to different instances of the feature. The labels “first,” “second,” and “third” when applied to a particular feature do not imply any type of ordering (e.g., spatial, temporal, logical, etc.), unless stated otherwise.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function. This unprogrammed FPGA may be “configurable to” perform that function, however.

Reciting in the appended claims that a structure is “configured to” perform one or more tasks is expressly intended not to invoke 35 U.S.C. § 112(f) for that claim element. Should Applicant wish to invoke Section 112(f) during prosecution, it will recite claim elements using the “means for” [performing a function] construct.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

What is claimed is:

1. A method, comprising:
generating, by a computer system using a trained generative model, a current set of synthetic communications, wherein the generating includes inputting a set of conditions for the synthetic communications into the trained generative model, and wherein the trained generative model is generated by iteratively performing until a discriminator of the generative model determines that synthetic communications generated by the generative model satisfy a difference threshold:
generating, by a generator of the generative model based on a set of existing communications, a training set of synthetic communications; and
determining, by the discriminator of the generative model, one or more differences between the set of existing communications and the training set of synthetic communications;
updating the generator based on the one or more differences; and
training, by the computer system using the current set of synthetic communications and the set of existing communications, a machine learning model to evaluate newly initiated electronic communications.

2. The method of claim 1, further comprising:
identifying, by the computer system using the trained machine learning model, one or more newly initiated communications as atypical; and
performing, by the computer system based on identifying one or more newly initiated communications as atypical, one or more actions corresponding to the atypical newly initiated communications.

3. The method of claim 2, wherein the one or more actions include one or more of the following types of actions: rejecting the one or more newly initiated communications, escalating authentication for the one or more newly initiated communications, and transmitting the one or more newly initiated communications for additional review.

4. The method of claim 1, wherein synthetic communications generated by the trained generative model simulate new types of atypical communications that are different than atypical communications included in the set of existing communications.

5. The method of claim 1, wherein the set of conditions for the synthetic communications includes conditions based on which the synthetic communications are generated, and wherein the set of conditions includes categorical features that include both categorical variables and numerical variables of the set of existing communications.

6. The method of claim 1, wherein the trained generative model is further generated by:
identifying, by the discriminator of the generative model based on the one or more differences, whether ones of the set of existing communications and the set of synthetic communications are synthetic.

7. The method of claim 1, wherein the generative model is a conditional tabular generative adversarial network (CTGAN).

8. The method of claim 1, further comprising:
inputting, by the computer system, output of the machine learning model during training into a large language model (LLM), wherein the output of the machine learning model includes classifications for one or more of the set of synthetic communications and the set of existing communications input to the machine learning model during training.

9. The method of claim 8, further comprising:
automatically altering, by the computer system based on comparing output of the LLM with known labels for the set of synthetic communications and the set of existing communications, the machine learning model.

10. A non-transitory computer-readable medium having instructions stored thereon that are executable by a computing device to perform operations comprising:
generating, using a trained generative model, a current set of synthetic electronic communications, wherein input to the trained generative model includes a set of conditions for the synthetic electronic communications, and wherein the trained generative model is generated by iteratively performing until a discriminator of the generative model determines that synthetic electronic communications generated by the generative model satisfy a difference threshold:
generating, by a generator of the generative model based on existing electronic communications, a training set of synthetic electronic communications; and
determining, by the discriminator of the generative model, one or more differences between the existing electronic communications and the training set of synthetic electronic communications;
updating the generator based on the one or more differences; and
training, using the current set of synthetic electronic communications and the set of existing electronic communications, a machine learning classifier to classify one or more newly initiated electronic communications.

11. The non-transitory computer-readable medium of claim 10, wherein the operations further comprise:
classifying, using the trained machine learning classifier, one or more newly initiated electronic communications as atypical; and
performing, based on identifying one or more newly initiated electronic communications as atypical, one or more preventative actions.

12. The non-transitory computer-readable medium of claim 11, wherein the one or more preventative actions include one or more of the following types of actions: rejecting the one or more newly initiated electronic communications, escalating authentication for the one or more newly initiated electronic communications, and transmitting the one or more newly initiated electronic communications for additional review.

13. The non-transitory computer-readable medium of claim 10, further comprising:
generating one or more conditions in the set of conditions for the synthetic electronic communications, based on which the synthetic electronic communications are generated, wherein generating the one or more conditions includes:
generating a first set of categorical features from categorical variables of the existing electronic communications; and
transforming, using one or more feature transformation techniques, numerical features of the existing electronic communications to generate a second set of categorical features.

14. The non-transitory computer-readable medium of claim 10, wherein the set of conditions includes at least three different variables, the combination of which does not appear in existing electronic communications.

15. The non-transitory computer-readable medium of claim 10, wherein the operations further comprise:
inputting output of the machine learning classifier during training into a large language model (LLM), wherein the output of the machine learning classifier includes classifications for one or more of synthetic electronic communications and existing electronic communications input to the machine learning classifier during training; and
automatically altering, based on comparing output of the LLM with known labels for the synthetic electronic communications and the existing electronic communications, the machine learning classifier.

16. A method, comprising:
training, by a computer system based on existing communications, a generative model, wherein the training includes iteratively performing, until a discriminator of the generative model determines that synthetic communications generated by the generative model during training satisfy a difference threshold:
generating, by a generator of the generative model based on the existing communications, a training set of synthetic communications; and
determining, by the discriminator of the generative model, one or more differences between the existing communications and the training set of synthetic communications;
updating the generator based on the one or more differences; and
generating, by the computer system using the trained generative model, a current set of synthetic communications, wherein the generating includes inputting a set of conditions for the synthetic communications into the trained generative model;
training, by the computer system using the current set of synthetic communications generated by the trained generative model and the existing communications, a machine learning classifier to classify newly initiated communications; and
classifying, by the computer system using the trained machine learning classifier, one or more newly initiated electronic communications.

17. The method of claim 16, further comprising:
performing, by the computer system based on classifying one or more newly initiated communications as atypical, one or more actions corresponding to the atypical newly initiated communications.

18. The method of claim 17, wherein the synthetic communications generated by the generative model simulate new types of atypical communications that are different than atypical communications included in the existing communications, and wherein the one or more actions include one or more of the following types of actions: rejecting the one or more newly initiated communications, escalating authentication for the one or more newly initiated communications, and transmitting the one or more newly initiated communications for additional review.

19. The method of claim 16, further comprising:
inputting, by the computer system, output of the machine learning classifier during training into a large language model (LLM), wherein the output of the machine learning classifier includes classifications for one or more of synthetic communications and the existing communications input to the machine learning classifier during training; and
automatically altering, by the computer system based on comparing output of the LLM with known labels for the synthetic communications and the existing communications, the machine learning classifier.

20. The method of claim 16, wherein the generative model is a conditional tabular generative adversarial network (CTGAN).
